(19) United States
(12) Patent Application Publication
(10) Pub. No.: US 2024/0378349 A1
(43) Pub. Date: Nov. 14, 2024

(54) SYSTEM AND METHOD FOR VEHICLE DESIGN

(71) Applicant: Toyota Research Institute, Inc., Los Altos, CA (US)

(72) Inventors: Chenyang Yuan, Cambridge, MA (US); Nikos Arechiga Gonzalez, San Mateo, CA (US); Frank Permenter, Cambridge, MA (US)

(73) Assignees: Toyota Research Institute, Inc., Los Altos, CA (US); Toyota Jidosha Kabushiki Kaisha, Toyota-Shi (JP)

(21) Appl. No.: 18/451,207

(22) Filed: Aug. 17, 2023

Related U.S. Application Data
(60) Provisional application No. 63/465,613, filed on May 11, 2023.
(60) Provisional application No. 63/471,389, filed on Jun. 6, 2023.

(51) Int. Cl. G06F 30/27; G06F 30/15

(52) U.S. Cl. CPC G06F 30/27; G06F 30/15

(57) ABSTRACT

Systems, methods, and other embodiments described herein relate to generating vehicle design using a diffusion model. In one embodiment, a method includes generating an image based on a reference image and a text description of the reference image using a diffusion model. The method includes, based on whether the image meets a predetermined constraint, generating an intermediate image based on the image and the predetermined constraint using an analysis model such that the intermediate image is incrementally closer to meeting the predetermined constraint than the image, regenerating the image based on the intermediate image using the diffusion model, and outputting the image.

### CROSS-REFERENCE TO RELATED APPLICATION

This application claims priority to U.S. Provisional Patent Application No. 63/465,613 filed May 11, 2023, and U.S. Provisional Patent Application No. 63/471,389 filed Jun. 6, 2023, the contents of both are hereby incorporated by reference in their entirety.

### TECHNICAL FIELD

The subject matter described herein relates, in general, to systems and methods for vehicle design.

### BACKGROUND

Machine learning models are useful in generating data. Machine learning models may generate data based on text. However, the context in which the machine learning models can use the text is limited. As such, the machine learning models are incapable of generating data that meet a constraint provided in text format.

### SUMMARY

In one embodiment, a system for generating vehicle design using a diffusion model is disclosed. The system includes a processor and a memory in communication with the processor. The memory stores machine-readable instructions that, when executed by the processor, cause the processor to generate an image based on a reference image and a text description of the reference image using a diffusion model. The memory stores machine-readable instructions that, when executed by the processor, cause the processor to, based on whether the image meets a predetermined constraint, generate an intermediate image based on the image and the predetermined constraint using an analysis model such that the intermediate image is incrementally closer to meeting the predetermined constraint than the image, regenerate the image based on the intermediate image using the diffusion model, and output the image.

In another embodiment, a method for generating vehicle design using a diffusion model is disclosed. The method includes generating an image based on a reference image and a text description of the reference image using a diffusion model. The method includes, based on whether the image meets a predetermined constraint, generating an intermediate image based on the image and the predetermined constraint using an analysis model such that the intermediate image is incrementally closer to meeting the predetermined constraint than the image, regenerating the image based on the intermediate image using the diffusion model, and outputting the image.

In another embodiment, a non-transitory computer-readable medium for generating vehicle design using a diffusion model is disclosed. The non-transitory computer-readable medium includes instructions that, when executed by a processor, cause the processor to generate an image based on a reference image and a text description of the reference image using a diffusion model. The instructions include instructions to, based on whether the image meets a predetermined constraint, generate an intermediate image based on the image and the predetermined constraint using an analysis model such that the intermediate image is incrementally closer to meeting the predetermined constraint than the image, regenerate the image based on the intermediate image using the diffusion model, and output the image.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a data flow of a vehicle design system.

FIG. 2 illustrates one embodiment of the vehicle design system.

FIG. 3 is a flowchart illustrating one embodiment of a method associated with vehicle design.

### DETAILED DESCRIPTION

Systems, methods, and other embodiments associated with systems and methods for vehicle design are disclosed. Utilizing Generative AI (Artificial Intelligence) tools for vehicle design may lead to significant inefficiency as the Generative AI tools are not capable of considering constraints when generating vehicle designs, and as such, may generate vehicle designs that do not meet, as an example, engineering constraints such as drag coefficient. This may lead to generating multiple vehicle design iterations before achieving a vehicle design that meets the desired constraints.

Current methods for generating vehicle design using Generative AI tools may not include breakthrough creativity as the Generative AI tools may generate designs based on a distribution of existing designs. Further and as previously mentioned, the Generative AI tools do not consider constraints when generating designs. Although Generative AI tools may consider generalized text prompts that may further describe a reference image to be inputted to the Generative AI tools, the Generative AI tools cannot consider specific machine-interpretable representations such as drag coefficients and/or vehicle weight distribution when generating a design.

Accordingly, systems, methods, and other embodiments associated with vehicle design are disclosed. As an example, the system receives a reference image (e.g., an image of a vehicle) and a text prompt that describes the reference image (e.g., “Side view of a vehicle”). The system inputs the reference image and the text prompt to a diffusion model. As an example, the diffusion model may be a stable diffusion model. The diffusion model outputs an image based on the reference image and the text prompt. The system inputs the image into an analysis model. The system receives one or more predetermined constraints, such as a drag coefficient value and a vehicle weight distribution ratio. The analysis model determines whether the image meets the predetermined constraints. In the case that the image meets the predetermined constraints, the system outputs the image. In the case that the image does not meet the predetermined constraints, the analysis model alters the image generating an intermediate image that is incrementally closer to meeting the predetermined constraints than the image. As such, although the intermediate image may not meet the predetermined constraints, the intermediate image is closer to meeting the predetermined constraints than the image. The system then feeds the intermediate image into the diffusion model and the diffusion model generates an updated image based on at least the intermediate image. The system then feeds the updated image back into the analysis model to determine whether the image meets the predetermined constraints. The cycle may continue until the analysis model determines that the image meets the predetermined constraints.

The embodiments disclosed herein present various advantages over conventional technologies that generate vehicle design. First, the embodiments increase time efficiency based on the feedback loop between the diffusion model and the analysis model. Second, the embodiments are able to produce and fine-tune novel artistic designs that satisfy engineering constraints. Third, the embodiments alleviate miscommunication and extensive communication iterations between vehicle designers and vehicle engineers, ensuring that vehicle design goals and engineering constraints are met with significantly fewer communication iterations.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

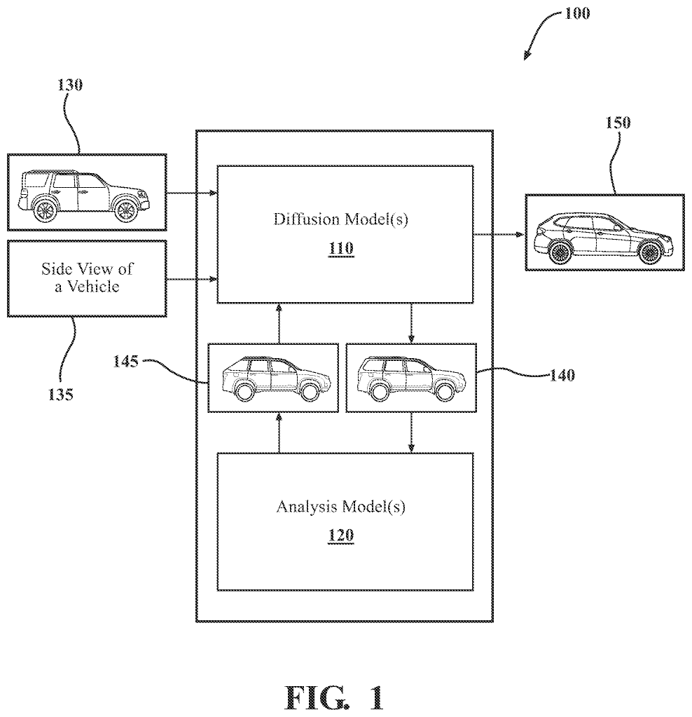

FIG. 1 illustrates a data flow of a vehicle design system 100. The vehicle design system 100 may include various elements, which may be communicatively linked in any suitable form. As an example, the elements may be connected, as shown in FIG. 1. Some of the possible elements of the vehicle design system 100 are shown in FIG. 1 and will now be described. It will be understood that it is not necessary for the vehicle design system 100 to have all the elements shown in FIG. 1 or described herein. The vehicle design system 100 may have any combination of the various elements shown in FIG. 1. Further, the vehicle design system 100 may have additional elements to those shown in FIG. 1. In some arrangements, the vehicle design system 100 may not include one or more of the elements shown in FIG. 1.

The vehicle design system 100 includes one or more diffusion models 110 and one or more analysis models 120. The diffusion model(s) 110 and the analysis model(s) 120 may be any suitable machine learning models.

The diffusion model 110 is a generative model. Generative models are a class of machine learning models that can generate new data based on training data. As an example, the diffusion model 110 is capable of generating images such as high-resolution images. The diffusion model 110 may generate an image 140 based on a reference image 130 and a text description 135 of the reference image 130. The text description 135 provides context to the diffusion model(s) 110. As such, the diffusion model 110 performs a guided image generation where the diffusion model 110 generates a detailed image 140 conditioned on both the reference image 130 and the text description 135. As an example, the diffusion model 110 may be a stable diffusion model, capable of generating and/or modifying images 140, 150 based on text prompts 135. In general, the diffusion model 110 receives a reference image 130 and a text prompt 135. The reference image 130 may be in any suitable format, such as in two-dimensional format, a three-dimensional format, and/or an audio format. The text prompt 135 describes the reference image 130 and is in a text format. In response to receiving the reference image 130 and the text prompt 135, the diffusion model 110 outputs an image 140, 150 in any suitable format based on and guided by the reference image 130 and the text prompt 135.

The analysis model 120 is a model that is capable of analyzing an image 140 and determining based on the analysis, whether a predetermined constraint has been met. The analysis model is also capable of altering the image 140, thereby generating an intermediate image 145 that is incrementally closer to meeting the predetermined constraint than the image 140. As such, the analysis model 120 may also be a generative model.

The predetermined constraint is a quantifiable or measurable characteristic of the object represented by the image 140. As an example, in the case of the image 140 being a vehicle as shown, the predetermined constraint may be a drag coefficient, a manufacturability criterion, a vehicle dimension, a vehicle structural strength, and/or a vehicle weight distribution. More generally, the predetermined constraint can be any constraint that is a differentiable function of the image 140. As such, the predetermined constraint can be a constraint that can be derived from the image 140. As an example, a differentiable analysis module may process the image and output any parameter of interest.

As an example of the predetermined constraint being a drag coefficient, the analysis model 120 receives a maximum drag coefficient value. In such an example, the analysis model 120 may determine the drag coefficient of an image 140 based on the size and shape of the image 140 using a suitable formula and/or method. The analysis model 120 may then compare the drag coefficient of the image 140 to the maximum drag coefficient value. In a case where the drag coefficient of the image 140 exceeds the maximum drag coefficient value, the analysis model 120 may alter the image 140 to reduce the drag coefficient of the image 140. The analysis model may alter the image 140 by altering the shape of the image 140 and/or by altering the size of the image 140, creating the intermediate image 145. The analysis model 120 may alter the image 140 without considering whether the resulting intermediate image 145 is a feasible design. As an example and as shown, to reduce the surface area of the image 140, the analysis model 120 may remove a portion of the front hood and a portion of the back of the vehicle, making the vehicle more streamlined. The analysis model 120 may determine that with the vehicle being more streamlined, the drag coefficient value is reduced and as such, is incrementally closer to meeting the maximum drag coefficient value.

As another example (not shown), to reduce the surface area of the image 140, the analysis model 120 may remove a portion of a wheel such that the wheel is no longer round. The analysis model 120 may determine that with less surface area, the drag coefficient value is reduced and as such, is incrementally closer to meeting the maximum drag coefficient value. The analysis model 120 may output the intermediate image 145 in any suitable format. As an example, the analysis model 120 may output the intermediate image 145 in a two-dimensional format, a three-dimensional format, an audio format, and/or a text format to the diffusion model 110.

In a case where the drag coefficient of the image 140 is less than or equal to the maximum drag coefficient value, the analysis model 120 may output a signal indicating that the drag coefficient of the image 140 is less than or meets the maximum drag coefficient value. In response to the signal, the diffusion model 110 may output the image 150.

As an example of the predetermined constraint being a manufacturability criterion, the analysis model 120 may receive a manufacturability criterion. A manufacturability criterion refers to factors to be considered during the manufacturing process of the object represented by the image 140. As an example, a manufacturability criterion may be the time in which the object is to be produced, the amount of computer and/or power resources available to produce the object, and/or the amount of material required to produce the object. The analysis model 120 may receive one or more manufacturability criteria. The manufacturability criteria may be based on a checklist of various factors that affect the manufacturing process of the object.

The analysis model 120 may apply any suitable method or formula to determine whether the object represented by the image 140 can be produced within the provided manufacturability criteria. As an example, the analysis model 120 may determine the time in which the object represented by the image 140 would be produced based on the size and shape of the image 140. In the case that the object represented by the image 140 cannot be produced within the provided manufacturability criteria, the analysis model 120 may alter the image 140, as previously mentioned, to generate the intermediate image 145 that may be closer to meeting the manufacturability criteria. The analysis model 120 may output the intermediate image 145 to the diffusion model 110. In the case that the object represented by the image 140 can be produced within the manufacturability criteria, the analysis model 120 may output a signal indicating that the image 140 meets the manufacturability criteria. In response to the signal, the diffusion model 110 may output the image 150.

As an example of the predetermined constraint being a vehicle dimension, the analysis model 120 may receive a minimum or maximum vehicle dimension. The vehicle dimension may be related to the whole vehicle or a portion of the vehicle such as the wheel of the vehicle, the body of the vehicle, the window(s) of the vehicle, the front hood of the vehicle, and/or the trunk of the vehicle. The analysis model 120 may receive one or more vehicle dimensions. The analysis model 120 may apply any suitable method or formula to determine whether the object represented by the image 140 meets the vehicle dimension(s). In the case that the object represented by the image 140 does not meet the vehicle dimension(s), the analysis model 120 may alter the image 140, as previously mentioned, to generate the intermediate image 145 that may be closer to meeting the vehicle dimensions. The analysis model 120 may output the intermediate image 145 to the diffusion model 110. In the case that the object represented by the image 140 meets the vehicle dimension(s), the analysis model may output a signal indicating that the image meets the vehicle dimension(s). In response to the signal, the diffusion model 110 may output the image 150.

As an example of the predetermined constraint being a vehicle structural strength, the analysis model 120 may receive any suitable vehicle structural strength values such as a strength-to-weight ratio. The analysis model 120 may apply any suitable method or formula to determine whether the object represented by the image 140 meets the vehicle structural strength value(s). In the case that the object represented by the image 140 does not meet the vehicle structural strength value(s), the analysis model 120 may alter the image 140, as previously mentioned, to generate the intermediate image 145 that may be closer to meeting the vehicle structural strength value(s). The analysis model 120 may output the intermediate image 145 to the diffusion model 110. In the case that the object represented by the image 140 meets the vehicle structural strength value(s), the analysis model 120 may output a signal indicating that the image meets the vehicle structural strength value(s). In response to the signal, the diffusion model 110 may output the image 150.

As an example of the predetermined constraint being a vehicle weight distribution, the analysis model 120 may receive a vehicle weight distribution ratio, referring to the distribution of the weight of the vehicle on the wheels of the vehicle. As an example, the vehicle weight distribution ratio may be a ratio of 50-50, such that 50 percent of the weight of the vehicle is on the front wheels and 50 percent of the weight of the vehicle is on the rear wheels. The analysis model 120 may apply any suitable method or formula to determine whether the object represented by the image 140 meets the vehicle weight distribution ratio. In the case that the object represented by the image 140 does not meet the vehicle weight distribution ratio, the analysis model 120 may alter the image 140, as previously mentioned, to generate the intermediate image 145 that may be closer to meeting the vehicle weight distribution ratio. The analysis model 120 may output the intermediate image 145 to the diffusion model 110. In the case that the object represented by the image 140 meets the vehicle weight distribution ratio, the analysis model 120 may output a signal indicating that the image 140 meets the vehicle weight distribution ratio. In response to the signal, the diffusion model 110 may output the image 150.

In general, the analysis model 120 receives an image 140, alters the image 140 to an intermediate image 145 based on whether the image 140 meets the predetermined constraint(s) and outputs the intermediate image 145 in any suitable format such as in a two-dimensional format, a three-dimensional format, and/or an audio format to the diffusion model 110.

In one embodiment, the analysis model 120 may receive more than one predetermined constraint. As such, the analysis model 120 may receive the predetermined constraint and a second predetermined constraint. The analysis model 120 may generate an intermediate image 145 based on the image 140 and the predetermined constraint, as previously mentioned. In one example, the analysis model 120 may generate a second intermediate image based on the image 140 and the second predetermined constraint. In such an example, the analysis model 120 may generate and output two intermediate images—an intermediate image 145 and a second intermediate image. In another example, the analysis model 120 may generate a second intermediate image based on the intermediate image 145, the image 140, the predetermined constraint, and the second predetermined constraint. In such an example, the analysis model 120 may generate two intermediate images—an intermediate image 145 and a second intermediate image and then, output the second intermediate image.

As an example and as shown, the vehicle design system 100 receives a reference image 130 of a vehicle and a text prompt 135 describing the reference image 130. More specifically, the diffusion model 110 receives the reference image 130 and the text prompt 135. The diffusion model 110 generates an image 140 based on the reference image 130 and the text prompt 135. The diffusion model 110 outputs the image 140 to the analysis model 120.

The analysis model 120 receives the image 140 and one or more predetermined constraints. The analysis model 120 determines whether the image 140 meets the predetermined constraint(s) as previously disclosed. In the case where the analysis model 120 determines that the image 140 meets the predetermined constraint(s), the analysis model 120 may output a signal to the diffusion model 110 to output the image 140. In response to the signal, the diffusion model 110 may output the image 150. In the case where the analysis model 120 determines that the image 140 does not meet the predetermined constraint(s), the analysis model 120 may alter the image 140 to an intermediate image 145 such that the intermediate image 145 is incrementally closer to meeting the predetermined constraint(s) than the image 140.

The diffusion model 110 receives the intermediate image 145 and generates an image 140 based on the intermediate image 145 and the text prompt 135. In another embodiment, the diffusion model 110 generates an image 140 based on the intermediate image 145, the reference image 130, and the text prompt 135. In another embodiment where the analysis model 120 generates and outputs two intermediate images (including the intermediate image 145), as previously mentioned, the diffusion model 110 generates an image 140 based on the two intermediate images (including the intermediate image 145) and the text prompt 135. Alternatively and/or additionally, the diffusion model 110 generates an image 140 based on the two intermediate images (including the intermediate image 145), the reference image 130, and the text prompt 135.

The diffusion model 110 outputs the image 140 to the analysis model 120 and as disclosed above, the analysis model 120 receives the image 140, determines whether the image 140 meets the predetermined constraint(s), and alters the image 140 or outputs a signal as previously disclosed. In other words, the cycle of the generation of images 140 by the diffusion model 110 and intermediate images 145 by the analysis model 120 may continue until the analysis model 120 determines that the image 140 meets the predetermined constraint(s).

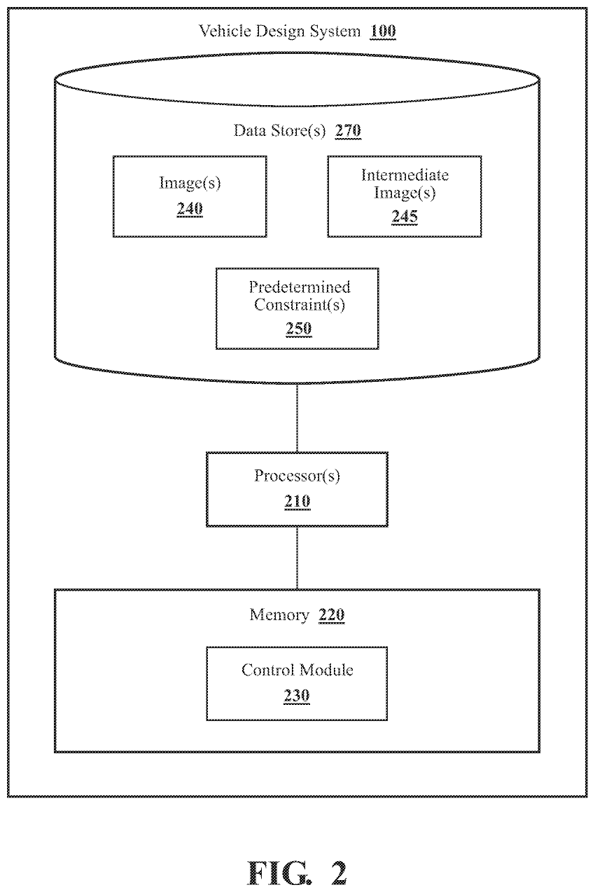

With reference to FIG. 2, one embodiment of the vehicle design system 100 of FIG. 1 is further illustrated. The vehicle design system 100 is shown as including a processor 210. Accordingly, the processor 210 may be a part of the vehicle design system 100, or the vehicle design system 100 may access the processor 210 through a data bus or another communication path. In one or more embodiments, the processor 210 is an application-specific integrated circuit (ASIC) that is configured to implement functions associated with a control module 230. In general, the processor 210 is an electronic processor, such as a microprocessor, that is capable of performing various functions as described herein.

In one embodiment, the vehicle design system 100 includes a memory 220 that stores the control module 230 and/or other modules that may function in support of generating vehicle design. The memory 220 is a random-access memory (RAM), read-only memory (ROM), a hard disk drive, a flash memory, or another suitable memory for storing the control module 230. The control module 230 is, for example, machine-readable instructions that, when executed by the processor 210, cause the processor 210 to perform the various functions disclosed herein. In further arrangements, the control module 230 is a logic, integrated circuit, or another device for performing the noted functions that includes the instructions integrated therein.

Furthermore, in one embodiment, the vehicle design system 100 includes a data store 270. The data store 270 is, in one arrangement, an electronic data structure stored in the memory 220 or another data store, and that is configured with routines that can be executed by the processor 210 for analyzing stored data, providing stored data, organizing stored data, and so on. Thus, in one embodiment, the data store 270 stores data used by the control module 230 in executing various functions.

For example, as depicted in FIG. 2, the data store 270 includes the images 240, the intermediate images 245, and the predetermined constraints 250, along with, for example, other information that is used and/or produced by the control module 230. The images 240 may include the images 140 generated by the diffusion model 110. The intermediate images 245 may include the intermediate images 145 and/or the second intermediate images generated by the analysis model 120. The predetermined constraints 250 may be generated and/or entered using any suitable means such as by a user.

While the vehicle design system 100 is illustrated as including the various data elements, it should be appreciated that one or more of the illustrated data elements may not be included within the data store 270 in various implementations and may be included in a data store that is external to the vehicle design system 100. In any case, the vehicle design system 100 stores various data elements in the data store 270 to support functions of the control module 230.

In one embodiment, the control module 230 includes instructions that, when executed by the processor(s) 210, cause the processor(s) 210 to generate an image 140 based on a reference image 130 and a text description 135 of the reference image 130 using a diffusion model 110.

In one or more arrangements and as mentioned above, the control module 230 can feed the reference image 130 and the text description 135 to the diffusion model 110 and the diffusion model 110 can generate the image 140.

In one embodiment, the control module 230 includes instructions that, when executed by the processor(s) 210, cause the processor(s) 210 to determine whether the image 140 meets a predetermined constraint 250 using an analysis model 120. In one or more arrangements, the control module 230 can feed the image 140 to the analysis model 120, and as previously disclosed, the analysis model 120 may determine whether the image 140 meets the predetermined constraint(s) 250.

In one embodiment, the control module 230 includes instructions that, when executed by the processor(s) 210, cause the processor(s) 210 to, based on whether the image 140 meets a predetermined constraint 250, generate an intermediate image 145 based on the image 140 and the predetermined constraint 250 using the analysis model 120, such that the intermediate image 145 is incrementally closer to meeting the predetermined constraint 250 than the image 140. In one or more arrangements and as mentioned above, the control module 230 can feed the image 140 and the predetermined constraint(s) 250 to the analysis model 120 and based on whether the image 140 meets the predetermined constraint(s), the analysis model 120 may generate the intermediate image 145. As previously mentioned, the intermediate image 145 may be based on the image 140 and the predetermined constraint(s) 250.

In one embodiment, the control module 230 includes instructions that, when executed by the processor(s) 210, cause the processor(s) 210 to, based on whether the image 240 meets a second predetermined constraint 250, generate a second intermediate image 245 based on the image 240 and the second predetermined constraint 250 using the analysis model 120, such that the second intermediate image 245 is incrementally closer to meeting the second predetermined constraint 250 than the image 240. In one or more arrangements and as mentioned above, the control module 230 can feed the image 240 and the predetermined constraints (i.e., the predetermined constraint and the second predetermined constraint) 250 to the analysis model 120 and based on whether the image 240 meets the predetermined constraint(s) 250, the analysis model 120 may generate the intermediate image 245 and/or the second intermediate image 245. As previously mentioned, the second intermediate image 245 may be based on the image 240, the intermediate image 245, the predetermined constraint 250, and/or the second predetermined constraint 250.

In one embodiment, the control module 230 includes instructions that, when executed by the processor(s) 210, cause the processor(s) 210 to, based on whether the image 140 meets the predetermined constraint(s) 250, regenerate the image 140 based on the intermediate image(s) 245, which may include the intermediate image 145 and the second intermediate image, using the diffusion model 110. In one or more arrangements, the control module 230 feeds the intermediate image(s) 245 to the diffusion model 110 and the diffusion model 110 regenerates an image 140 based on the intermediate image(s) 245 and the text description 135.

In one embodiment, the control module 230 includes instructions that, when executed by the processor(s) 210, cause the processor(s) 210 to, based on whether the image 140 meets the predetermined constraint(s) 250, output the image 150. In one or more arrangements, the control module 230 feeds the image 140 from the diffusion model 110 to the analysis model 120. In the case that the analysis model 120 determines that the image 140 meets the predetermined constraint(s) 250, the analysis model 120 can send a signal to the control module 230, indicating that the image 140 meets the predetermined constraint(s), the control module 230 may then output the image 140 generated by the diffusion model 110 as the output image 150. In the case that the analysis model 120 determines that the image 140 does not meet the predetermined constraint(s) 250, the analysis model 120 can alter and generate the intermediate images 145, 245 as previously mentioned.

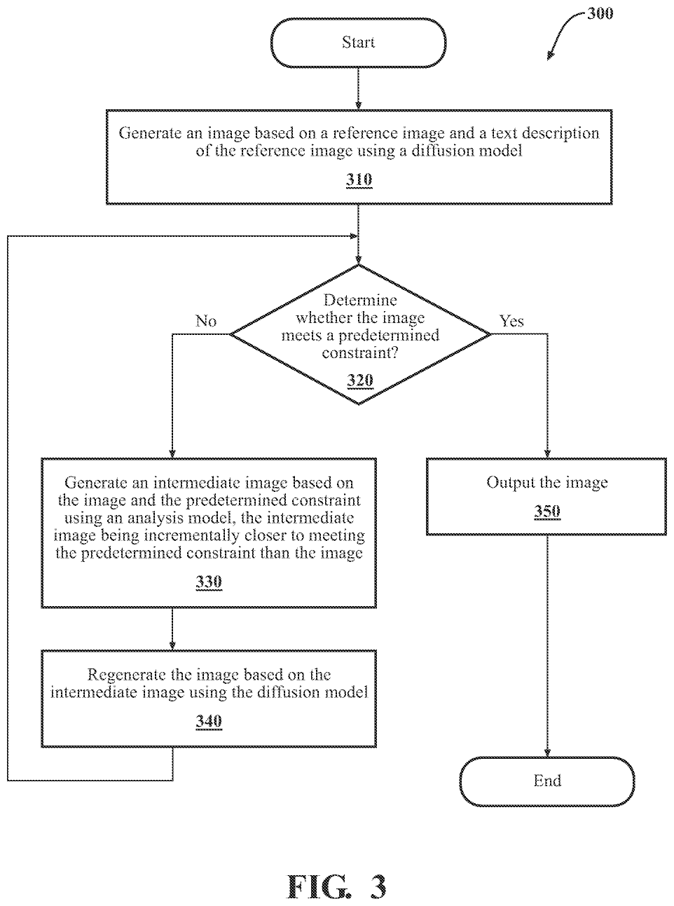

FIG. 3 is a flowchart illustrating one embodiment of a method 300 associated with vehicle design. The method 300 will be described from the viewpoint of the vehicle design system 100 of FIGS. 1-2. However, the method 300 may be adapted to be executed in any one of several different situations and not necessarily by the vehicle design system 100 of FIGS. 1-2.

At step 310, the control module 230 may cause the processor(s) 210 to generate an image 140 based on a reference image 130 and a text description 135 of the reference image 130 using a diffusion model 110. The control module 230 may feed the reference image 130 and the text description 135 of the reference image 130 to the diffusion model 110, and the diffusion model 110 may generate an image 140 based on the reference image 130 and the text description 135 of the reference image 130. The next step is step 320.

At step 320, the control module 230 may cause the processor(s) 210 to determine whether the image 140 meets a predetermined constraint 250. As an example, the control module 230 may feed the image 140 to an analysis model 120, and the analysis model 120 may determine whether the image 140 meets the predetermined constraint 250. In the case where the analysis model 120 determines that the image 140 does not meet the predetermined constraint 250, the next step is step 330. In the case where the analysis model 120 determines that the image 140 meets the predetermined constraint 250, the next step is step 350.

At step 330, the control module 230 may cause the processor(s) 210 to generate an intermediate image 145 based on the image 140 and the predetermined constraint 250 using the analysis model 120 such that the intermediate image 145 is incrementally closer to meeting the predetermined constraint 250 than the image 140. The next step is step 340.

At step 340, the control module 230 may cause the processor(s) 210 to regenerate the image 140 based on the intermediate image 145 using the diffusion model 110. The next step is step 320.

At step 350, the control module 230 may cause the processor(s) 210 to output the image 140 from the diffusion model 110 as the image 150.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-3, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory storing machine-readable instructions that, when executed by the processor, cause the processor to:
generate an image based on a reference image and a text description of the reference image using a diffusion model; and
based on whether the image meets a predetermined constraint:
generate an intermediate image based on the image and the predetermined constraint using an analysis model, the intermediate image being incrementally closer to meeting the predetermined constraint than the image;
regenerate the image based on the intermediate image using the diffusion model; and
output the image.

2. The system of claim 1, wherein the image is a representation of a vehicle.

3. The system of claim 1, wherein the intermediate image is in one of:
a two-dimensional format;
a three-dimensional format; or
an audio format.

4. The system of claim 1, wherein the predetermined constraint is based on one of:
a drag coefficient;
a manufacturability criterion;
a vehicle dimension;
a vehicle structural strength;
a vehicle weight distribution; or
a differentiable function of the image.

5. The system of claim 1, wherein the machine-readable instructions further include instructions that when executed by the processor cause the processor to:
based on whether the image meets a second predetermined constraint:
generate a second intermediate image based on the image and the second predetermined constraint using a second analysis model, the second intermediate image being incrementally closer to meeting the second predetermined constraint than the image;
regenerate the image further based on the second intermediate image using the diffusion model; and
output the image.

6. The system of claim 1, wherein the machine-readable instructions further include instructions that when executed by the processor cause the processor to:
determine whether the image meets the predetermined constraint using the analysis model.

7. The system of claim 1, wherein the diffusion model is a stable diffusion model.

8. A method comprising:
generating an image based on a reference image and a text description of the reference image using a diffusion model; and
based on whether the image meets a predetermined constraint:
generating an intermediate image based on the image and the predetermined constraint using an analysis model, the intermediate image being incrementally closer to meeting the predetermined constraint than the image;
regenerating the image based on the intermediate image using the diffusion model; and
outputting the image.

9. The method of claim 8, wherein the image is a representation of a vehicle.

10. The method of claim 8, wherein the intermediate image is in one of:
a two-dimensional format;
a three-dimensional format; or
an audio format.

11. The method of claim 8, wherein the predetermined constraint is based on one of:
a drag coefficient;
a manufacturability criterion;
a vehicle dimension;
a vehicle structural strength;
a vehicle weight distribution; or
a differentiable function of the image.

12. The method of claim 8, further comprising:
based on whether the image meets a second predetermined constraint:
generating a second intermediate image based on the image and the second predetermined constraint using a second analysis model, the second intermediate image being incrementally closer to meeting the second predetermined constraint than the image;
regenerating the image further based on the second intermediate image using the diffusion model; and
outputting the image.

13. The method of claim 8, further comprising:
determining whether the image meets a predetermined constraint using the analysis model.

14. The method of claim 8, wherein the diffusion model is a stable diffusion model.

15. A non-transitory computer-readable medium including instructions that when executed by a processor cause the processor to:
generate an image based on a reference image and a text description of the reference image using a diffusion model; and
based on whether the image meets a predetermined constraint:
generate an intermediate image based on the image and the predetermined constraint using an analysis model, the intermediate image being incrementally closer to meeting the predetermined constraint than the image;
regenerate the image based on the intermediate image using the diffusion model; and
output the image.

16. The non-transitory computer-readable medium of claim 15, wherein the image is a representation of a vehicle.

17. The non-transitory computer-readable medium of claim 15, wherein the intermediate image is in one of:
a two-dimensional format;
a three-dimensional format; or
an audio format.

18. The non-transitory computer-readable medium of claim 15, wherein the predetermined constraint is based on one of:
a drag coefficient;
a manufacturability criterion;
a vehicle dimension;
a vehicle structural strength;
a vehicle weight distribution; or
a differentiable function of the image.

19. The non-transitory computer-readable medium of claim 15, wherein the instructions further include instructions that when executed by the processor cause the processor to:
based on whether the image meets a second predetermined constraint:
generate a second intermediate image based on the image and the second predetermined constraint using a second analysis model, the second intermediate image being incrementally closer to meeting the second predetermined constraint than the image;
regenerate the image further based on the second intermediate image using the diffusion model; and
output the image.

20. The non-transitory computer-readable medium of claim 15, wherein the instructions further include instructions that when executed by the processor cause the processor to:
determine whether the image meets a predetermined constraint using the analysis model.
